(19) United States
(12) Patent Application Publication
(10) Pub. No.: US 2015/0230205 A1
(43) Pub. Date: Aug. 13, 2015

(54) METHOD OF PERFORMING MBMS COUNTING PROCEDURE IN WIRELESS COMMUNICATION SYSTEM

(71) Applicant: ACER INCORPORATED, New Taipei City (TW)

(72) Inventor: Miao-Er Lin, New Taipei City (TW)

(21) Appl. No.: 14/572,775

(22) Filed: Dec. 17, 2014

Related U.S. Application Data
(60) Provisional application No. 61/938,702, filed on Feb. 12, 2014.

(30) Foreign Application Priority Data
Jul. 24, 2014 (TW) 103125325

(51) Int. Cl. H04W 72/00; H04W 28/02; H04L 12/18; H04W 4/06

(52) U.S. Cl. CPC H04W 72/005; H04W 4/06; H04W 28/02; H04L 12/189

(57) ABSTRACT

In an MBMS counting procedure, a base station is configured to designate one or more operational modes using the reserved bits of the DCI 1C format or by inserting one indicator bit in a counting request message. According to the reserved bits or the indicator bit, only the user equipment which operates in the RRC idle mode is configured to reply a counting response message, only the user equipment which operates in the RRC connected mode is configured to send a counting reply message, or all user equipment is configured to send a counting reply message.

### CROSS REFERENCE TO RELATED APPLICATIONS

This application claims the benefit of U.S. provisional application No. 61/938,702 filed on Feb. 12, 2014.

### BACKGROUND OF THE INVENTION

1. Field of the Invention

The present invention is related to a method of performing an MBMS counting procedure in a wireless communication system, and more particularly, to a method of performing an MBMS counting procedure in a wireless communication system for requesting user equipment operating in a specific mode to respond.

2. Description of the Prior Art

The 3rd Generation Partnership Project (3GPP) has developed a universal mobile telecommunications system (UMTS) which adopts a wideband code division multiple access (WCDMA) technology capable of providing high frequency spectrum utilization, universal coverage, and high-speed/quality multimedia data transmission. In the UMTS, a radio access network known as a universal terrestrial radio access network (UTRAN) includes multiple base stations, commonly known as Node-Bs (NBs), for communicating with multiple user equipment (UE). Furthermore, a long-term evolution (LTE) system is now being developed by the 3GPP in order to further improve performance of the UMTS to satisfy users' increasing needs. The LTE system includes a new radio interface and radio network architecture which provides a high data rate, low latency, packet optimization, and improved system capacity and coverage. In the LTE system, a radio access network known as an evolved UTRAN (E-UTRAN) includes multiple evolved NBs (eNBs) for communicating with multiple UEs. LTE radio interface protocols include an access stratum (AS) layer and a non-access stratum (NAS) layer. The AS layer includes a physical layer (L1), a data link layer (L2) and a network layer (L3). The network layer controls a radio resource control (RRC layer). The data link layer includes a packet data convergence protocol (PDCP), a radio link control (RLC) and a medium access control (MAC). The NAS layer handles the communication between the UE and the core network (CN) which includes a mobility management entity (MME), a serving gateway and other devices.

Multimedia Broadcast Multicast Service (MBMS) is a Point-to-Multipoint (PTM) interface specification designed to provide efficient delivery of broadcast and multicast services within 3GPP cellular networks. Examples of MBMS interface specifications include those described in UMTS and LTE communication specifications. For broadcast transmission across multiple cells, the specifications define transmission over single-frequency network configurations. Intended applications include mobile TV, news, radio broadcasting, file delivery, emergency alerts, and others. When services are broadcasted by MBMS, all cells inside a multimedia broadcast multicast service single frequency network (MBSFN) area transmit the same MBMS service. Meanwhile, MBMS supports two logical channels for PTM downlink transmissions: a multicast control channel (MCCH) and a multicast traffic channel (MTCH), both of which are mapped to an MBMS transport channel, such as a multicast channel (MCH). The MCCH is used for transmitting all MBMS control messages within the MBSFN area, while the MTCH is used for transmitting the MBMS session data.

The base station may broadcast a system information block 13 (SIB13) message and an MBSFNAreaConfiguration message in order to notify the sub-frames assigned to MBMS transmission and related configuration settings, based on which a multi-cell/multicast coordinate entity (MCE) may manage MBMS resources.

In order to acquire the amount of UEs which are using or interested in MBMS services (hereafter as MBMS-active UEs), the base station is configured to initiate a counting procedure by sending a CountingRequest message. According to related 3GPP specifications, a UE can receive MBMS contents when operating in a radio resource control (RRC) connected mode or an RRC idle mode. However, only the UE operating in the RRC connected mode is able to reply the CountingRequest message sent by the base station. Therefore, the prior art method of performing the MBMS counting procedure fails to provide an accurate result of the amount of UEs which are using or interested in MBMS services.

### SUMMARY OF THE INVENTION

The present invention provides a method of performing an MBMS counting procedure in a wireless communication system which includes a base station and a user equipment. The method includes the base station setting at least one reserved bit in a DCI format of a PDCCH, wherein the at least one reserved bit is associated with a specific operation mode of the user equipment which the base station designates as a responding operation mode; the base station transmitting an M-RNTI associated with the DCI format via the PDCCH using a downlink bandwidth; and the base station transmitting a counting request message via an MCCH.

The present invention also provides a method of performing an MBMS counting procedure in a wireless communication system which includes a base station and a user equipment. The method includes the base station transmitting an M-RNTI via a PDCCH; the base station determining whether to insert an indicator bit into a counting request message based on a specific operational mode of the user equipment which the base station designates as a responding operation mode; and the base station transmitting the counting request message via an MCCH.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to an embodiment of the present invention.

FIG. 2 is a diagram illustrating a communication device according to an embodiment of the present invention.

FIG. 3 is a diagram illustrating a program code applied to an LTE system according to an embodiment of the present invention.

FIG. 4 is a flowchart illustrating a method of performing an MBMS counting procedure in an LTE system according to an embodiment of the present invention.

FIG. 5 is a flowchart illustrating a method of performing an MBMS counting procedure in an LTE system according to an embodiment of the present invention.

### DETAILED DESCRIPTION

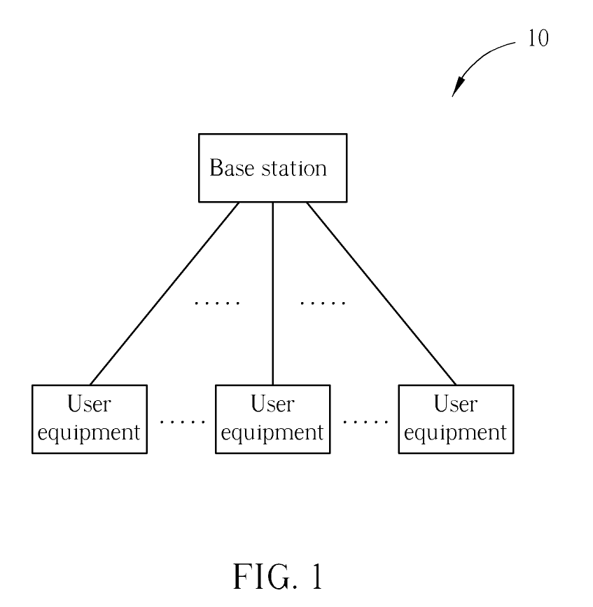

FIG. 1 is a diagram illustrating a wireless communication system 10 according to an embodiment of the present invention. The wireless communication system 10, including a base station and multiple UEs, may preferably be an LTE system or another network system which supports multiple components carriers. In the LTE system, the base station may be an eNB of the EUTRAN. Each UE may include electronic devices, such as mobile telephones, personal digital assistants, handheld, tablet, nettop, or laptop computers, or other devices with similar telecommunication capabilities. However, the types of the base station and the UEs do not limit the scope of the present invention. Also, the base station and each UE may either be a transmitter or a receiver. For uplink (UL) transmissions, the UEs are transmitters and the base station is a receiver for. For downlink (DL) transmissions, the base station is a transmitter and the UEs are receivers.

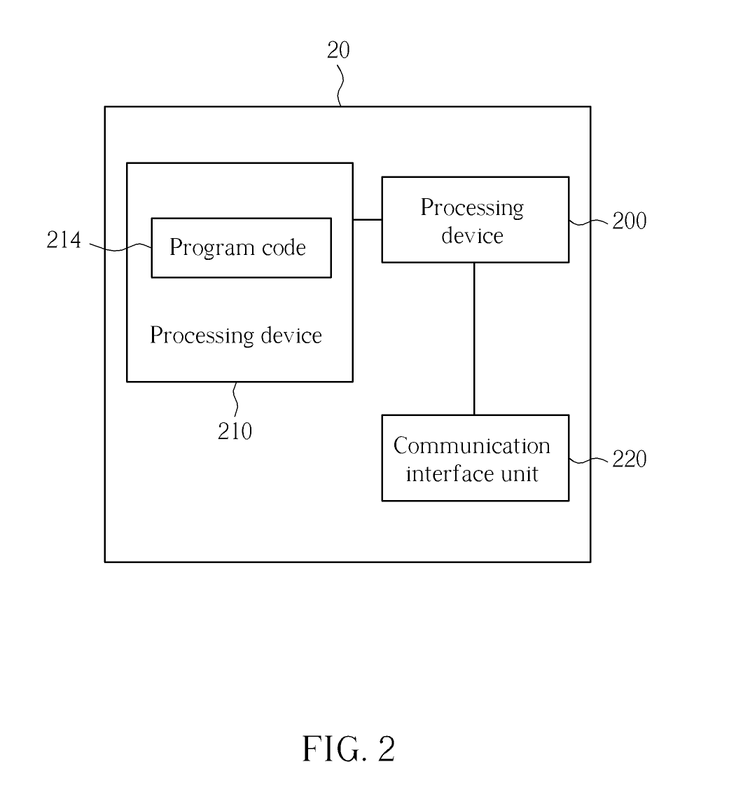

FIG. 2 is a diagram illustrating a communication device 20 according to an embodiment of the present invention. The communication device 20, which may be the UE or the base station depicted in FIG. 1, includes a processing device 200, a storage unit 210 and a communication interface unit 220. The processing device 200 may be a microprocessor or an application-specific integrated circuit (ASIC). The storage unit 210 may be any data storage device capable of storing a program code 214 which may be accessed and executed by the processing device 200. For example, the storage unit 210 may be a subscriber identity module (SIM) card, read-only memory (ROM), random-access memory (RAM), a CD-ROM, a magnetic tape, a floppy disk, or an optical data storage device. The communication interface unit 220 may be a wireless transceiver configured to communicate with other devices wirelessly and convert the computation result of the processing device 200 into wireless signals.

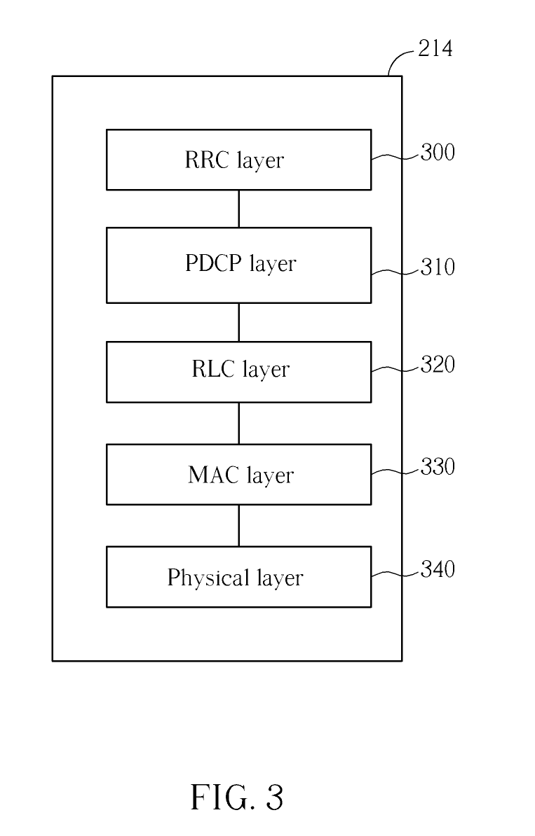

FIG. 3 is a diagram illustrating the program code 214 applied to the LTE system according to an embodiment of the present invention. The program code 214 includes codes associated with a plurality of communication protocol layers which are, from top to bottom, an RRC layer 300, a PDCP layer 310, an RLC layer 320, a MAC layer 330, and a physical layer 340. The physical layer 340 includes a plurality of physical channels, such as a physical random access channel (PRACH), a physical uplink control channel (PUCCH), a physical uplink shared channel (PUSCH), a physical downlink control channel (PDCCH) and a physical downlink shared channel (PDSCH), etc.

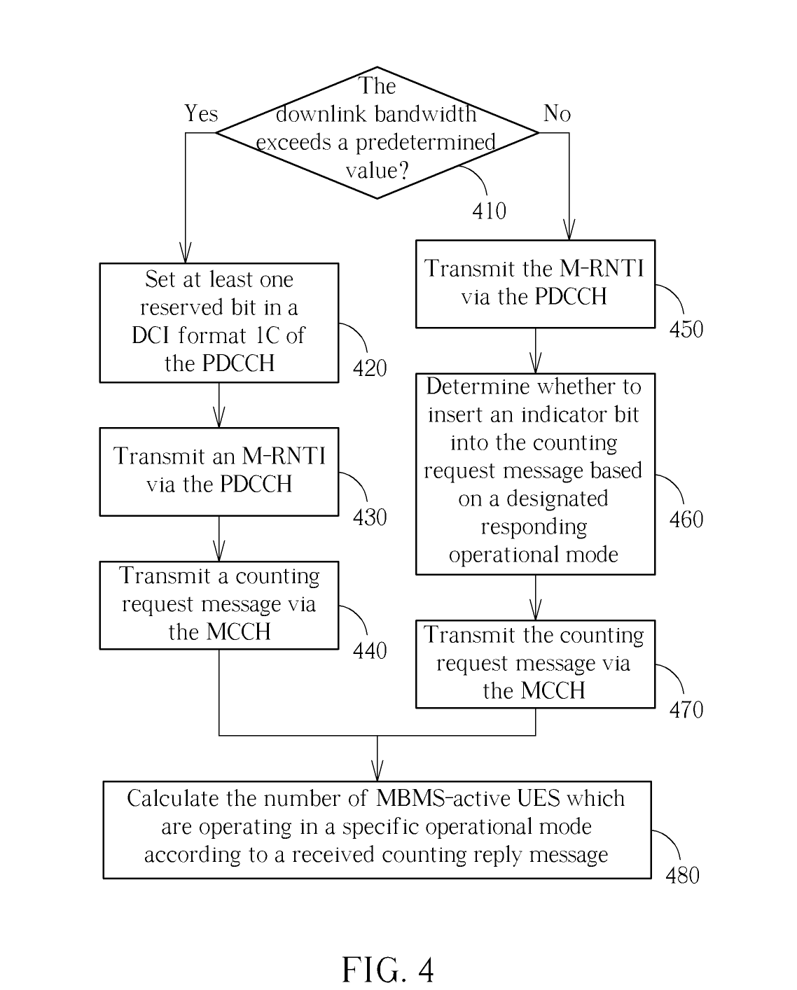

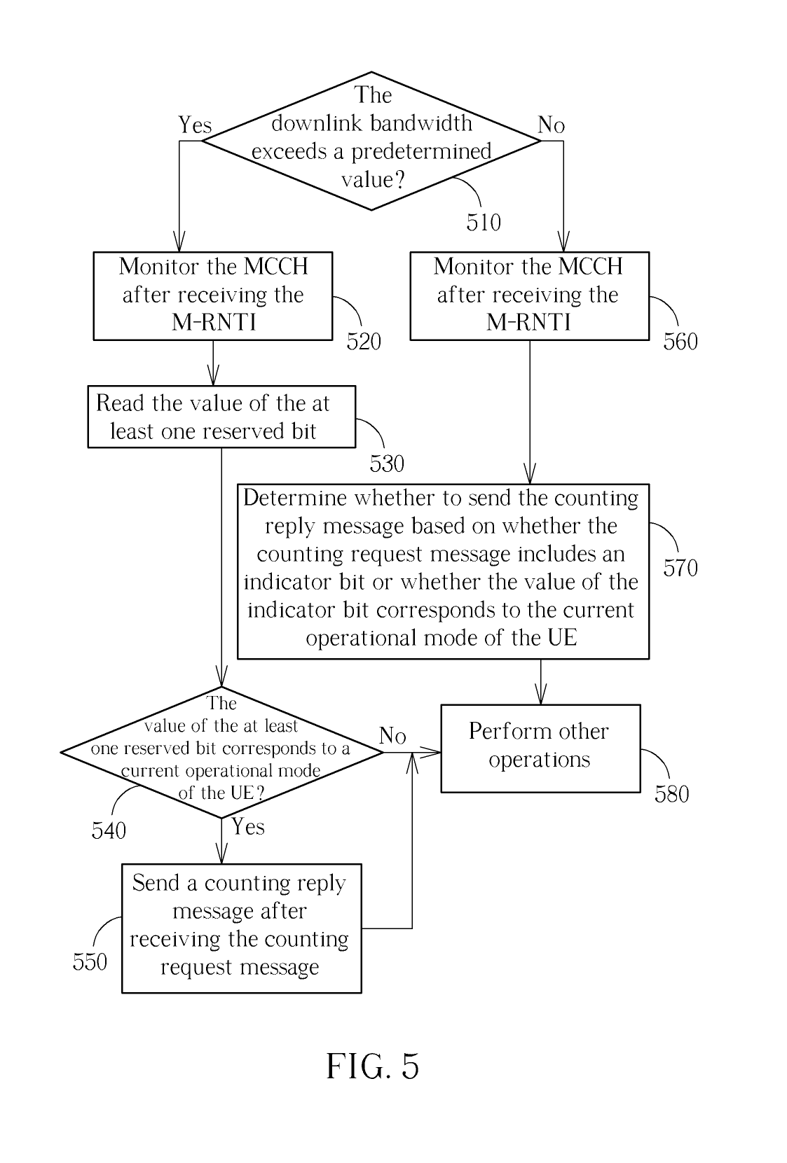

FIGS. 4 and 5 are flowcharts illustrating methods of performing a MBMS counting procedure in an LTE system according to an embodiment of the present invention. FIG. 4 illustrates the operation of the base station which may be installed with the program code 214 for executing the following steps:

Step 410: determine if the downlink bandwidth exceeds a predetermined value; if yes, execute step 420; if no, execute step 450.

Step 420: set at least one reserved bit in a downlink control information (DCI) format 1C of the PDCCH; execute step 430.

Step 430: transmit an MBMS radio network temporary identifier (M-RNTI) via the PDCCH; execute step 440.

Step 440: transmit a counting request message via the MCCH; execute step 480.

Step 450: transmit the M-RNTI via the PDCCH; execute step 460.

Step 460: determine whether to insert an indicator bit into the counting request message based on a designated responding operational mode; execute step 470.

Step 470: transmit the counting request message via the MCCH; execute step 480.

Step 480: calculate the number of MBMS-active UES which are operating in a specific operational mode according to a received counting reply message.

FIG. 5 illustrates the operation of the UE which may be installed with the program code 214 for executing the following steps:

Step 510: determine if the downlink bandwidth exceeds a predetermined value; if yes, execute step 520; if no, execute step 560.

Step 520: monitor the MCCH after receiving the M-RNTI; execute step 530.

Step 530: read the value of the at least one reserved bit; execute step 540.

Step 540: determine if the value of the at least one reserved bit corresponds to a current operational mode of the UE; if yes, execute step 550; if no, execute step 580.

Step 550: send a counting reply message after receiving the counting request message; execute step 580.

Step 560: monitor the MCCH after receiving the M-RNTI; execute step 570.

Step 570: determine whether to send the counting reply message based on whether the counting request message includes an indicator bit or whether the value of the indicator bit corresponds to the current operational mode of the UE; execute step 580.

Step 580: perform other operations.

The following table illustrates an embodiment of the DCI 1C format of the PDCCH. The M-RNTI is arranged to signal changes in the MCCH using 8 bits in the DCI 1C format. When the downlink bandwidth exceeds 1.4 MHz, the DCI 1C format includes at least 2 reserved bits.

| Name | Length (bits) | Frequency (MHz) |
|---|---|---|
| MCCH change notification | 8 | |
| Reserved bit | | 1.4 |
| | 2 | 3 |
| | 4 | 5 |
| | 5 | 10 |
| | 6 | 15 |
| | 7 | 20 |

When it is determined in steps 410 and 510 that the downlink bandwidth exceeds 1.4 MHz, the base station is configured to set one or multiple reserved bits in the DCI format 1C in step 420, transmit the M-RNTI via the PDCCH in step 430, and transmit the counting request message via the MCCH in step 440. After receiving the M-RNTI in step 520, all MBMS-active UEs can be notified of changes in the MCCH. The MCCH changes may be caused by the MBMS counting request, or by the state variation during the MBMS session (such as activating/terminating the MBMS session). Therefore, all MBMS-active UEs are configured to monitor the MCCH in step 520 and read the value of the one or multiple reserved bits in step 530. However, a specific UE is configured to send the counting reply message in response to the counting request message in step 550 only after determining that the value of the at least one reserved bit corresponds to the current operational mode of the specific UE in step 540.

In a wideband embodiment of the present invention (such as when the downlink bandwidth exceeds 1.4 MHz), if the base station sets two reserved bits (R1, R2) in the DCI format 1C as (0, 0), all MBMS-active UEs are configured to monitor the MCCH after receiving the M-RNTI, but only the MBMS-active UEs which are currently operating in the RRC connected mode are configured to send the counting reply message after receiving the counting request message. Therefore, the base station may acquire the number of MBMS-active UEs which are currently operating in the RRC connected mode in step 480.

In another wideband embodiment of the present invention (such as when the downlink bandwidth exceeds 1.4 MHz), if the base station sets two reserved bits (R1, R2) in the DCI format 1C as (0, 1), all MBMS-active UEs are configured to monitor the MCCH after receiving the M-RNTI, but only the MBMS-active UEs which are currently operating in the RRC idle mode are configured to send the counting reply message after receiving the counting request message. Therefore, the base station may acquire the number of MBMS-active UEs which are currently operating in the RRC idle mode in step 480.

In another wideband embodiment of the present invention (such as when the downlink bandwidth exceeds 1.4 MHz), if the base station sets two reserved bits (R1, R2) in the DCI format 1C as (1, 0), all MBMS-active UEs are configured to monitor the MCCH after receiving the M-RNTI and send the counting reply message after receiving the counting request message. Therefore, the base station may acquire the number of all MBMS-active UEs in step 480.

When it is determined in steps 410 and 510 that the downlink bandwidth does not exceed 1.4 MHz, the base station is configured to transmit the M-RNTI via the PDCCH in step 450, insert the indicator bit into the counting request message according to the designated responding operational mode, and transmit the counting request message via the MCCH in step 470. All MBMS-active UEs are configured to monitor MCCH after receiving the M-RNTI in step 560. After receiving the counting request message in step 570, all MBMS-active UEs are configured to determine whether to send the counting reply message based on whether the counting request message includes the indicator bit or whether the value of the indicator bit corresponds to the current operational mode of the UEs.

In a narrowband embodiment of the present invention (such as when the downlink bandwidth does not exceed 1.4 MHz), no indicator bit is inserted into the counting request message in step 460 if the base station only needs to calculate the number of MBMS-active UEs which are currently operating in the RRC connected mode. After receiving the M-RNTI in step 560, all MBMS-active UEs are configured to monitor the MCCH and may determine that the counting request message received in step 570 does not include any indicator bit. Under such circumstance, only the MBMS-active UEs which are currently operating in the RRC connected mode are configured to send the counting reply message after receiving the counting request message. Therefore, the base station may acquire the number of MBMS-active UEs which are currently operating in the RRC connected mode in step 480.

In another narrowband embodiment of the present invention (such as when the downlink bandwidth does not exceed 1.4 MHz), an indicator bit of 0 may be inserted into the counting request message in step 460 if the base station only needs to calculate the number of MBMS-active UEs which are currently operating in the RRC idle mode. After receiving the M-RNTI in step 560, all MBMS-active UEs are configured to monitor the MCCH and may determine that the counting request message received in step 570 include the indicator bit of 0. Under such circumstance, only the MBMS-active UEs which are currently operating in the RRC idle mode are configured to send the counting reply message after receiving the counting request message. Therefore, the base station may acquire the number of MBMS-active UEs which are currently operating in the RRC idle mode in step 480.

In another narrowband embodiment of the present invention (such as when the downlink bandwidth does not exceed 1.4 MHz), an indicator bit of 1 may be inserted into the counting request message in step 460 if the base station needs to calculate the number of all MBMS-active UEs. After receiving the M-RNTI in step 560, all MBMS-active UEs are configured to monitor the MCCH and may determine that the counting request message received in step 570 include the indicator bit of 1. Under such circumstance, all MBMS-active UEs are configured to send the counting reply message after receiving the counting request message. Therefore, the base station may acquire the number of all MBMS-active UEs in step 480.

The above mentioned wideband and narrowband embodiments are merely illustrated examples of the present counting procedure. However, the method of setting the reserved bits and the relationship between the value of the reserved bits and the assigned responding operational mode do not limit the scope of the present invention.

In the present invention, the base station may request the MBMS-active UEs which are currently operating in the RRC idle mode to send the counting reply message using the reserved bits in the DCI format 1C or by inserting an indicator bit in the counting request message, thereby acquiring the accurate number of the MBMS-active UEs. Also, the base station may only request the MBMS-active UEs which are currently operating in a specific mode to send the counting reply message, thereby preventing resource congestion caused by all MBMS-active UEs simultaneously sending the counting reply message.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of performing a multimedia broadcast multicast service (MBMS) counting procedure in a wireless communication system which includes a base station and a user equipment, the method comprising:
the base station setting at least one reserved bit in a first downlink control information (DCI) format of a physical downlink control channel (PDCCH), wherein the at least one reserved bit is associated with a specific operation mode of the user equipment which the base station designates as a responding operation mode;
the base station transmitting a first MBMS radio network temporary identifier (M-RNTI) associated with the first DCI format via the PDCCH using a first downlink bandwidth; and
the base station transmitting a first counting request message via a multicast control channel (MCCH).

2. The method of claim 1, further comprising:
the user equipment monitoring the MCCH after receiving the first M-RNTI;
the user equipment reading a value of the at least one reserved bit; and
the user equipment sending a counting reply message after receiving the first counting request message when the value of the at least one reserved bit corresponds to a current operational mode of the user equipment.

3. The method of claim 1, further comprising:
the base station setting a first reserved bit and a second reserved bit in the first DCI format for designating a radio resource control (RRC) connected mode, designating an RRC idle mode, or designating both the RRC connected mode and the RRC idle mode defined in a 3rd Generation Partnership Project (3GPP) specification.

4. The method of claim 1, further comprising:
the base station transmitting a second M-RNTI associated with a second DCI format via the PDCCH using a second downlink bandwidth;
the base station determining whether to insert an indicator bit into a second counting request message based on the specific operational mode; and
the base station transmitting the second counting request message via the MCCH.

5. The method of claim 4, further comprising:
the user equipment monitoring the MCCH after receiving the second M-RNTI; and
the user equipment determining whether to send a counting reply message in response to the second counting request message based on whether the second counting request message includes the indicator bit or whether the value of the indicator bit corresponds to a current operational mode of the user equipment.

6. The method of claim 4, wherein:
the base station does not insert the indicator bit into the second counting request message for designating a radio resource control (RRC) connected mode defined in a 3rd Generation Partnership Project (3GPP) specification;
the base station inserts the indicator bit of a first value into the second counting request message for designating an RRC idle mode defined in the 3GPP specification; and
the base station inserts the indicator bit of a second value into the second counting request message for designating both the RRC connected mode and the RRC idle mode.

7. The method of claim 4, wherein the first downlink bandwidth is larger than the second downlink bandwidth.

8. The method of claim 1, wherein the first DCI format is a DCI 1C format defined in a defined in a 3rd Generation Partnership Project specification.

9. A method of performing a multimedia broadcast multicast service (MBMS) counting procedure in a wireless communication system which includes a base station and a user equipment, the method comprising:
the base station transmitting an MBMS radio network temporary identifier (M-RNTI) via a physical downlink control channel (PDCCH);
the base station determining whether to insert an indicator bit into a counting request message based on a specific operational mode of the user equipment which the base station designates as a responding operation mode; and
the base station transmitting the counting request message via a multicast control channel (MCCH).

10. The method of claim 9, further comprising:
the user equipment monitoring the MCCH after receiving the M-RNTI; and
the user equipment determining whether to send a counting reply message in response to the counting request message based on whether the counting request message includes the indicator bit or whether the value of the indicator bit corresponds to a current operational mode of the user equipment.

11. The method of claim 9, wherein:
the base station does not insert the indicator bit into the counting request message for designating a radio resource control (RRC) connected mode defined in a 3rd Generation Partnership Project (3GPP) specification;
the base station inserts the indicator bit of a first value into the counting request message for designating an RRC idle mode defined in the 3GPP specification; and
the base station inserts the indicator bit of a second value into the counting request message for designating both the RRC connected mode and the RRC idle mode.
